(19) United States
(12) Patent Application Publication
(10) Pub. No.: US 2009/0168423 A1
(43) Pub. Date: Jul. 2, 2009

(54) Energy-saving recessed tracklight system

(76) Inventor: Jack V. Miller, Seaford, DE (US)

Correspondence Address: Jack V. Miller, 20915 Sussex Hwy., Seaford, DE, 19973, US

(21) Appl. No.: 12/005,088

(22) Filed: Dec. 26, 2007

(51) Int. Cl. H05B 33/02; F21V 7/06

(52) U.S. Cl. 362/260; 362/310

(57) ABSTRACT

A tracklight system includes an elongated an elongated metallic track in the shape of an inverted U having a generally horizontal base with parallel, vertical depending sides, each side terminating at a distal end in a common plane with an outward facing support flange for a ceiling panel. The inward-facing side of at least one side supports an elongated 3-conductor electrical receptacle having polarized longitudinal slots holding electrical conductors therein. A number of lamp assemblies are positionable in longitudinal slots each with flexible wires terminating in a plug matching the polarized electrical receptacle. A thermal barrier in the ceiling plane prevents lamp heat from radiating in the downward direction into a room.

U.S. patent references Cited:

U.S. Pat. No. 7,223,002—Miller, et al—Hybrid fiber optic framing projector

U.S. Pat. No. 6,439,749—Miller, et al—Internal fixture tracklight system

U.S. Pat. No. 5,325,272—Miller—Fiber optic track lighting system

U.S. Pat. No. 5,303,125—Miller, et al—Fiber optic aimable spotlight luminaire

U.S. Pat. No. 5,099,399—Miller, et al—Thermally controlled fiber optic illuminator

D405,898—Miller, et al—Internally illuminated lighting track

NP-1 Non-patent document—T-bar mount

NP-2 Non-patent document—Recessed T-bar fiber track

NP-3 Non-patent document—Fiber optic room illumination

### FIELDS OF THE INVENTION

The present invention relates to the fields of tracklight systems that have aimable light fixtures that are variably spaced, mechanically supported and electrically connected along an elongated track; suspended ceiling T-bar main runners used to support cross-T beams and ceiling panels; and recessed lighting fixtures that include lamps above a ceiling that emit light though lenses or apertures in the ceiling plane.

### BACKGROUND—DESCRIPTION OF PRIOR ART

Prior art tracklight systems have aimable light fixtures that depend into a room from elongated tracks and are mechanically supported and electrically connected within the tracks as shown in the applicant's U.S. Pat. No. 4,822,292. This prior art tracklght is typical of literally hundreds of such products used in commercial, residential and retail lighting.

Track luminaires (depending light fixtures) almost universally use lamps known as MR-16, (Miniature Reflector lamps, 16 ⅛ths of an inch in diameter) that produce both light and heat. The most efficient of such lamps emit approximately 10% of their energy as visible light, and 90% of their energy as IR (infrared) heat and including a small amount of UV (ultraviolet) energy. It is well known that UV and IR contribute only to photochemical damage, and that they do not contribute to vision, but instead actually inhibit vision. Further, the non-visible energy is radiated in light beams and omnidirectionally from all sides of the luminaires, thus requiring air conditioning to remove the radiant, invisible energy to maintain proper room temperatures in the room.

One prior-art tracklight system that does not emit UV or IR into a room is shown in the applicants' prior art U.S. Pat. No. 5,325,272, that has been in use for a number of years to provide light with no UV or IR to illuminate museum artifacts. The '272 patent teaches a recessed lighting track for fiber optic luminaires that also supports suspended ceiling panels as shown in the NP-1 non-patent prior art reference. The '272 prior-art track is ideal in its ability to emit controlled, non-damaging light through fiber optics. However, it does not provide the ability to use track lamps with sufficient lumen output for general illumination. Thus the lamp heat must be located in and dissipated from a remote fiber optic light projector as shown in the NP-2 non-patent prior art reference.

The NP-3 non-patent document is a photograph of a period room in a museum, lighted entirely with fiber optics, with a 150-watt fiber optic projector light source above the ceiling. No air conditioning is needed in the room because there is no lighting heat in the room. Although fiber optic lighting is both economical and energy conserving, the fiber optic projector must be above the ceiling, requiring access for relamping. Further, if the ceiling is plaster of drywall, relamping must be done in a crawl space.

### OBJECTS OF THE PRESENT INVENTION

The principal objects of the present invention are to provide a suspended ceiling tracklight system that provides:

1) a structural main runner support for cross-T beams and ceiling panels that includes aimable luminaires recessed within the track that do not depend into the room below the ceiling;

2) a visible-light-transmitting, ceiling-to-plenum thermal barrier in the ceiling plane that substantially blocks the transmission of lamp IR heat and UV energy into the room;

3) a thermal control system in recessed track luminaires that substantially dissipates lamp heat above the ceiling;

4) lamp access from below the ceiling for relamping by removal of a ceiling-to-plenum thermal barrier; and

5) the ability to use a variety of single-circuit and 3-way incandescent and compact fluorescent lamps having varying wattages, in single-circuit and 3-way screw-base lamp holders.

### BRIEF DESCRIPTION OF THE DRAWINGS

FIG. 1 is a drawing of typical prior art tracklights shown depending from a ceiling, wherein View A is a line-voltage tracklight, View B is a tracklight with a low-voltage transformer and View C is a line-voltage, internally-ballasted fluorescent luminaire, all of which emit 100% of thrir lamp energy into a room and therefore require air conditioning power to remive the lamp heat;

FIG. 2 is a lateral cross-sectional view of the track main runner of the present invention having an optical axis therethrough;

FIG. 3 is a lateral cross-sectional view of the tracklight system of the present invention, showing an overhead suspension wire and supporting either a T-bar cross member or a suspended ceiling panel, and including a lampholder assembly, power receptacles and a ceiling thermal barrier;

FIG. 4 is a longitudinal cross-sectional view of a preferred embodiment of the recessed track system of the present invention, taken along section line A-A of FIG. 3 and using an incandescent, tungsten-halogen, MR (Miniature Reflector) lamp in the lampholder assembly;

FIG. 5 is a longitudinal cross-sectional view of a preferred embodiment of the recessed track system of the present invention, taken along section line A-A of FIG. 3 and using a compact fluorescent lamp in the lampholder assembly;

FIG. 6 is a perspective view of the incandescent MR reflector lamp in the lampholder assembly of FIG. 4;

FIG. 7 is a longitudinal cross-sectional view of the incandescent parabolic reflector lamp in the lampholder assembly of FIG. 4, shown on the optical axis along with an aimable filter/reflector assembly;

FIG. 8 is a lateral cross-sectional view of the track system of the present invention, taken along section line B-B of FIG. 7 and showing a heat-absorbing filter;

FIG. 9 is a perspective view of the incandescent parabolic reflector lamp in the lampholder assembly with the aimable filter/reflector assembly of FIG. 7;

FIG. 10 is a lateral cross-sectional view of the tracklight system of the present invention, showing transverse aiming angles T;

FIG. 11 is a perspective view of the compact fluorescent lamp of FIG. 5 in the lampholder assembly.

FIG. 12 is a longitudinal cross-sectional view of the compact fluorescent lamp in the lampholder assembly of FIG. 5 and FIG. 11, shown on the optical axis along with a downlight reflector assembly;

FIG. 13 is a perspective view of the compact fluorescent lamp in the lampholder assembly of FIG. 5, shown on the optical axis along with the downlight reflector of FIG. 12;

FIG. 14 is a lateral cross-sectional view of the tracklight system of the present invention, showing the compact fluorescent lamp of FIG. 5 within the downlight reflector of FIG. 12 FIG. 13;

FIG. 15 is a longitudinal cross-sectional view of an alternate embodiment of the present invention having a back-to-back single-circuit lampholders on the optical axis, and including two incandescent or compact fluorescent lamps operable in a 3-way mode from a 3-wire power plug; and

FIG. 16 is a perspective view of and incandescent and a compact fluorescent lamp in the lampholder assembly of FIG. 15.

### DETAILED DESCRIPTION OF THE DRAWINGS

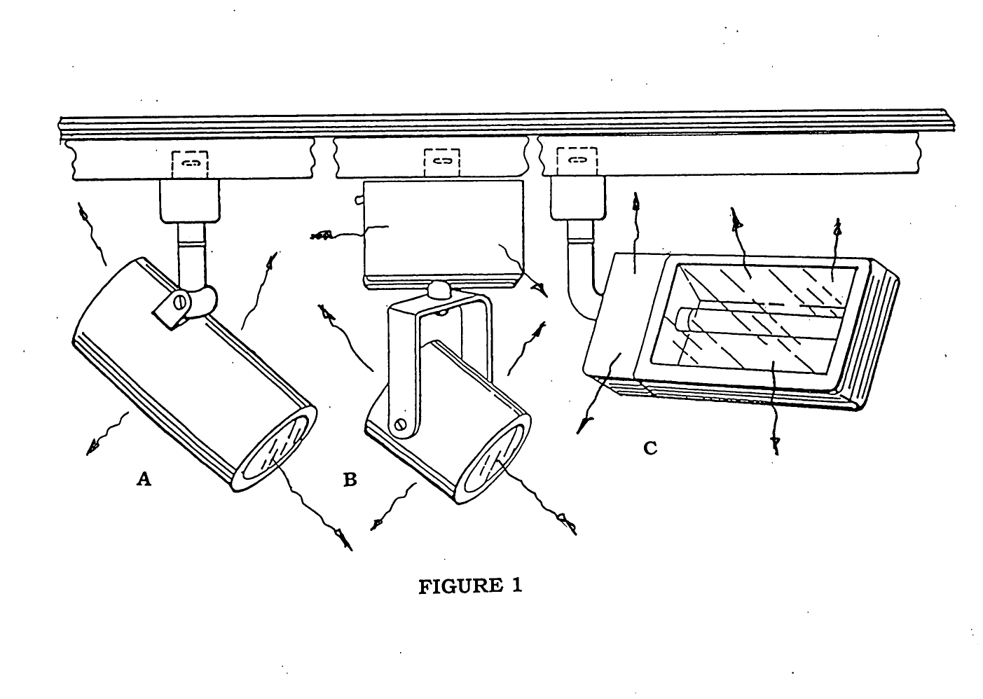

In FIG. 1 typical prior art tracklights are shown depending below a ceiling, and wherein 100% of the total lamp energy, both visible and invisible, is emitted into the room, normally requiring air conditioning the remove the lamp heat to maintain the selected room temperature.

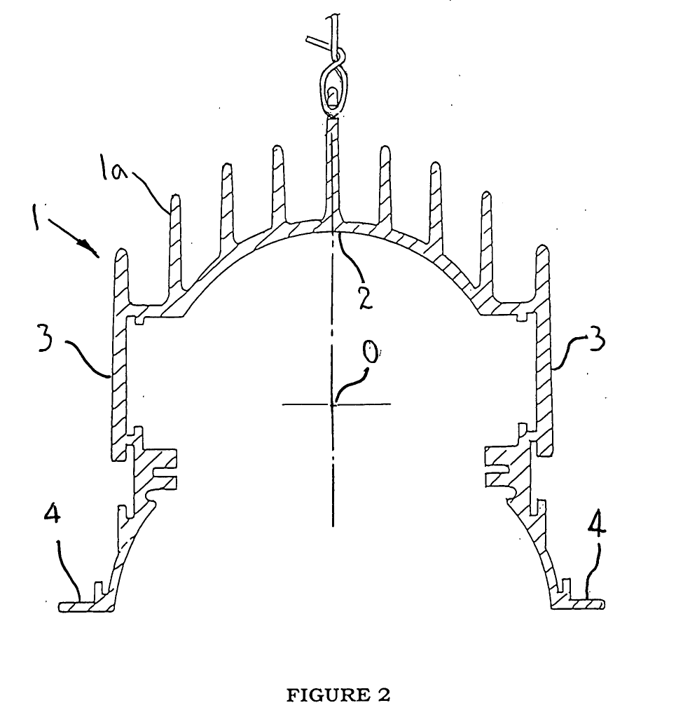

In FIG. 2 the present invention tracklight system (1) is shown to include an elongated metallic main-runner track (1a) generally in the shape of an inverted U, having a horizontal base portion (2) and first and second depending vertical sides (3) approximately equally spaced from an optical axis (O), said sides having lower ends extending downwards from the base of the U to form outward-extending flanges (4) in a common plane. In the preferred embodiment the track is made of a black anodized aluminum extrusion having high internal IR absorption and high external IR radiation.

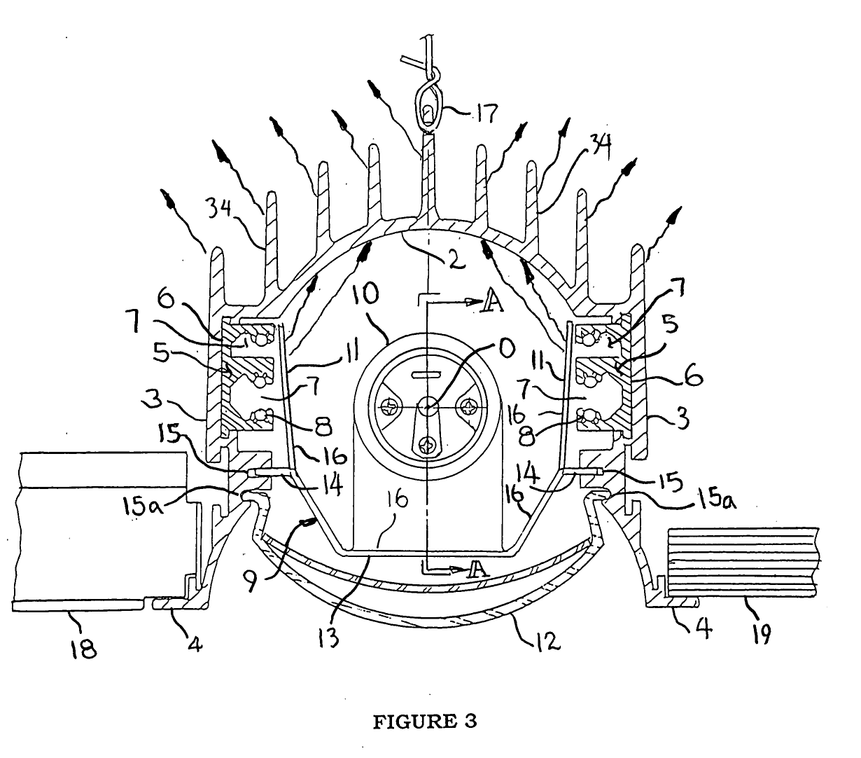

In FIG. 3 an elongated power insulator (5) is shown attached in a channel (6) in at least one of the depending vertical sides (3), said insulator including 2 polarized longitudinal slots (7) with partially-imbedded electrical conductors (8), connected to remotely-switched electrical power mains (not shown). Slots (7) are polarized preclude connection reversal.

A lamp assembly (9) includes a horizontally positioned screw-base lampholder (10) located on a longitudinal optical axis (O) that is approximately centered below base (2) of the track. Lampholder (10) is attached to a chassis (9) in the form of an upstanding U-shape wherein the base (13) of the U-shaped chassis terminates in outstanding flanges (14) that are slidably engaged into opposing slots (15) in depending vertical sides (3). Chassis (12) also includes upstanding sides (11) extending vertically to each side of the a horizontal base portion (2) of track (1) and covering elongated insulators (5) in depending vertical sides (3).

The lamp assembly chassis is provided with heat reflecting surfaces (16) facing the optical axis (O), whereby heat emitted from a lamp (not shown) installed in lampholder (10) is substantially reflected upwards towards horizontal base portion (2). In a preferred embodiment lampholder (10) is a 3-way lampholder having an electrically neutral screw shell, a first central contact and a second intermediate contact to provide 3-way operation of 3-way lamps, but single-circuit operation for lamps having a neutral screw shell and one central power contact. Thus 3-way lamp operation of 3-way lamps may be controlled by remote switching of the three conductors (8) in either insulating channel (5).

The tracklight system may be suspended from an overhead by wires (17) or other convenient structures, and in turn may support either inverted T-bar cross beams and/or ceiling panels (19). A thermal barrier (12) blocks IR radiation from being emitted below the ceiling. Although this is a strogly preferred element of the invention, it would be apparent to one skilled in the art that it could be omitted. However, the result would be an open bottom tracklight that emits IR and UV into the room.

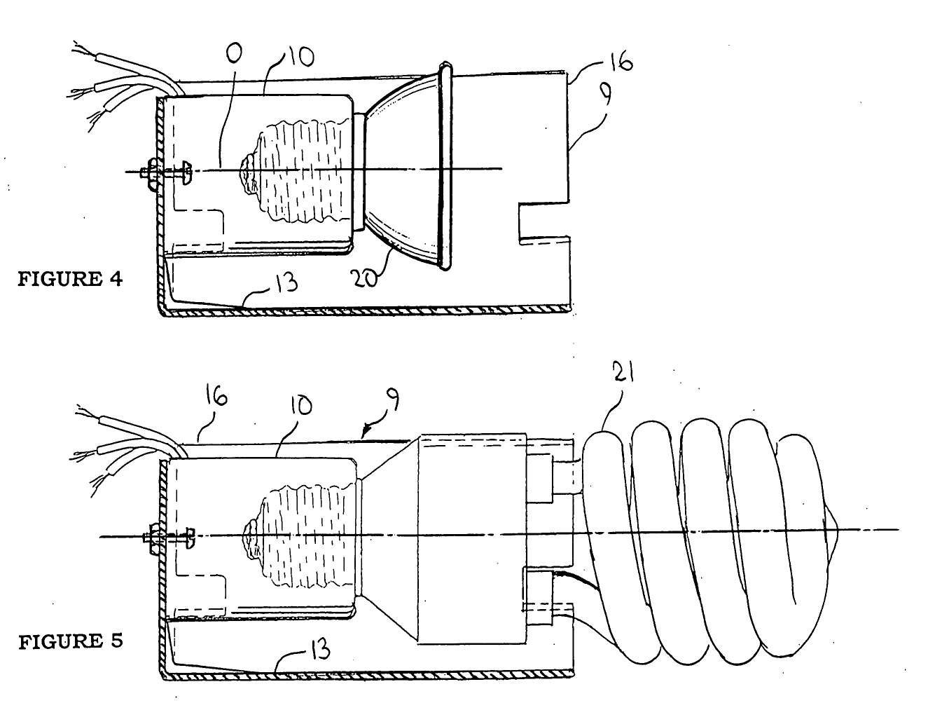

In FIG. 4, a longitudinal cross-sectional view of the lampholder assembly (9) shown, taken along section line A-A of FIG. 3, including a typical tracklight MR-16 Miniature Reflector lamp (20) shown on optical axis (O) of lampholder assembly (9).

In FIG. 5 a longitudinal cross-section view of the lampholder assembly (9) taken along section line A-A of FIG. 3 is shown with a compact fluorescent lamp (21) in lampholder (10). The compact fluorescent lamp may be a 40 watt lamp giving a 150 watt incandescent equivalent output, or a 12-19-28 watt 3-way fluorescent lamp having an incandescent equivalent of 30-60-100 watts. This provides the ability to remotely adjust room brightness to match occupancy and use factors with minimum energy.

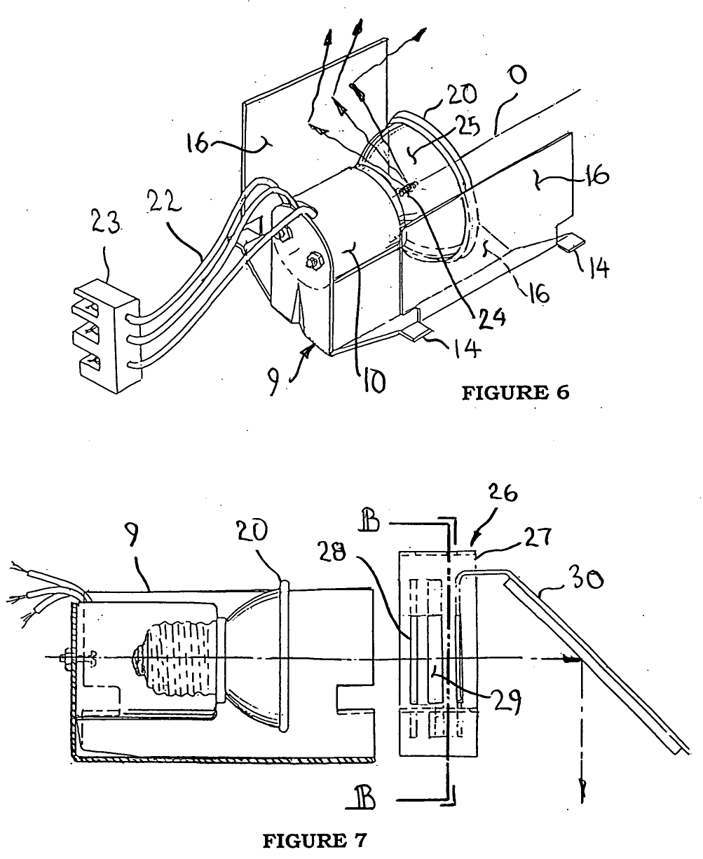

FIG. 6 is a perspective view of the incandescent MR-16 reflector lamp in the lampholder assembly of FIG. 4. The MR-16 lamp (20) shown is an example of a number of parabolic reflector lamps having an incandescent filament (24) on optical axis (O) within a dichroic glass reflector 25 that is transparent to IR and reflects substantially visible light into a collimated beam. Thus the IR heat from the filament passes through reflector (25) to reflective surfaces (16) that reflect the IR upwards, towards the base (2) of track (1) as shown in FIG. 3. Lamp (20) is energized from the lampholder (10) having wires (22) leading from a polarized plug (23) that matches an elongated polarized electrical receptacle (5) and contacts power conductors (8) that are energized from remotely-switched power mains.

In FIG. 7 is an aimable filter/reflector assembly (2) is shown on optical axis (O) of the incandescent parabolic reflector lamp (20) in the lampholder assembly (9) of FIG. 4, shown on optical axis (O) along with a visible light transmitting, IR-reflecting dichroic “hot mirror” (28) and a heat-absorbing lens (29) held in a filter bracket (27) along with a generally downward by off-axis mirror (30). Thus the light beam from lamp (20) is substantially IR filtered before reaching off-axis mirror (30).

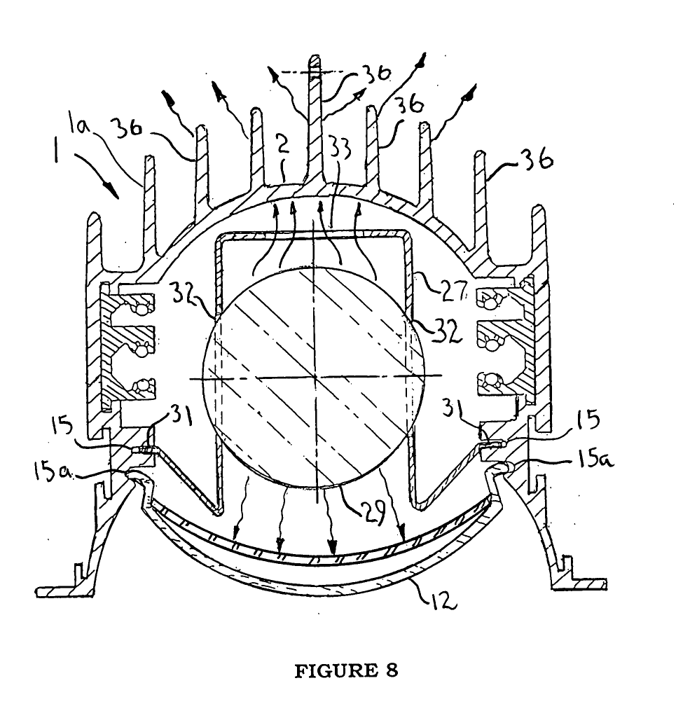

In FIG. 8 a lateral cross-sectional view of the track system of the invention is taken along section line B-B of FIG. 7 and shows the filter/mirror bracket (27) is supported by outstanding tabs (31) engaged into opposing slots (15a) in depending sides (3). Filter/mirror bracket (27) holds the heat-absorbing lens (29) held in a opposing slots 32. The top of filter/reflector bracket (27) is provided with a convection port (33) allowing heat from the heat-absorbing lens (29) to be transferred to base (2) of main-runner track, to be conducted to cooling fins (34) and emitted above the ceiling plane. The minor amount of IR radiated in the downward direction is blocked by thermal barrier (12), comprising at least one elongated lens of an IR-blocking material such as polymethyl methacrylate or polycarbonate plastics being approximately in the ceiling plane and engaged into opposing slot 15a on either side.

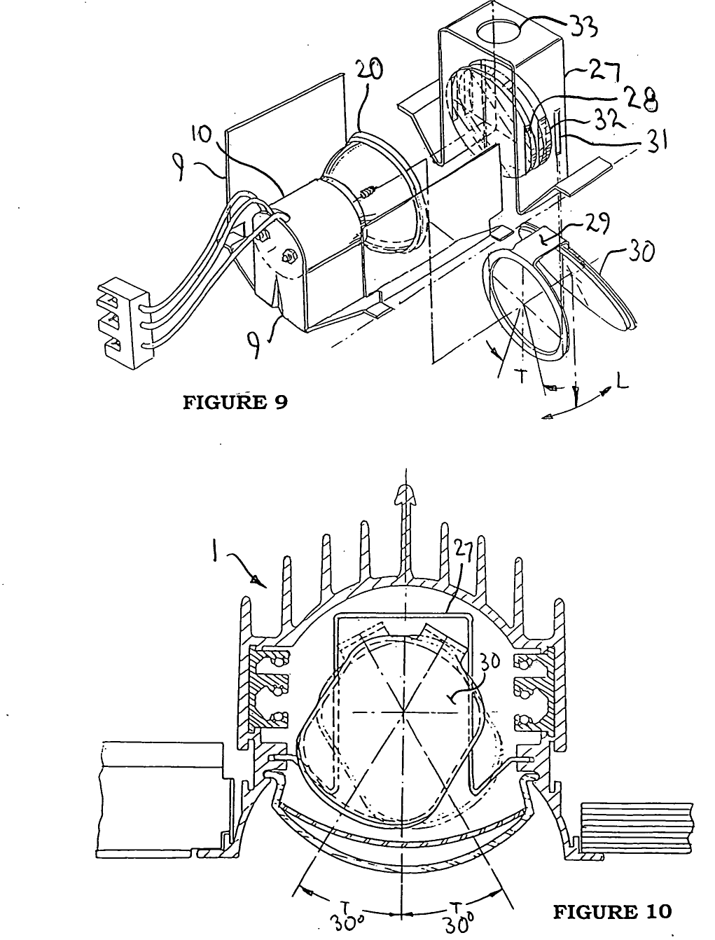

In FIG. 9 a perspective view of the incandescent reflector lamp (20) in lampholder assembly (9) shows the aimable filter/reflector assembly of FIG. 7, with the off-axis aiming mirror (30) shown with transverse aiming T by rotation within slot (31) of filter/reflector bracket (27), and with longitudinal aiming in direction L by bending the arm (29) of mirror (30).

In FIG. 10 the lateral cross-sectional view of the tracklight system of the present invention, shows transverse aiming angles T of mirror (30) to be approximately ±30° off axis.

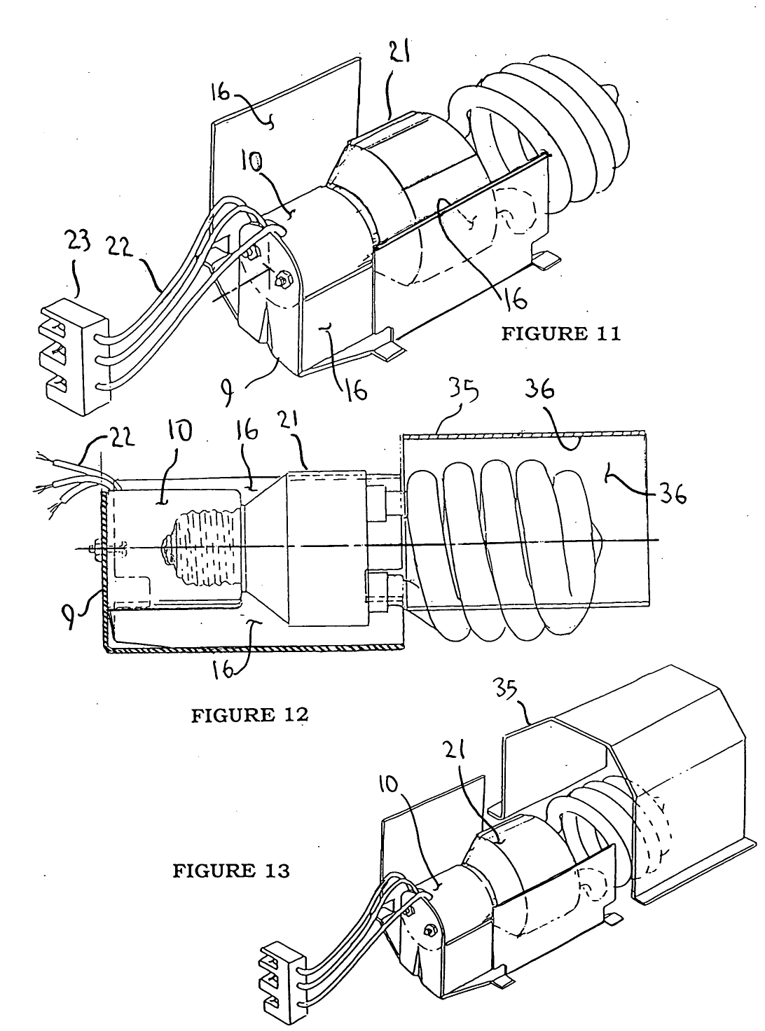

In FIG. 11 a perspective view of the compact fluorescent lamp (21) of FIG. 5 in the lampholder assembly (9) is shown in lampholder (10) connected by 3 wires (22) to a 3-conductor polarized plug adapted to receive power from the conductors (8) on insulating channels (5). Internal reflective surfaces (16) of lampholder assembly (9) reflect ballast and electrode heat generally upwards, and internal reflective surfaces (36) of downlight reflector (35) reflect visible light generally downwards into the room below the ceiling FIG. 12 shows a longitudinal cross-sectional view of the compact fluorescent lamp (21) in the lampholder assembly (9) of FIG. 5 and FIG. 11, shown on the optical axis along with a downlight reflector assembly (35).

In FIG. 13 a perspective view of the compact fluorescent lamp (21) in the lampholder assembly of FIG. 12, clarifies the view of FIG. 12.

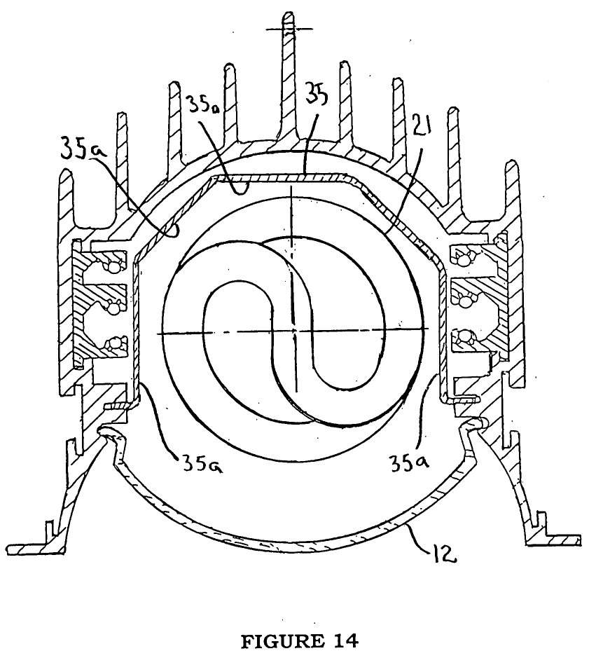

FIG. 14 shows a lateral cross-sectional view of the tracklight system (1a) of the present invention, showing the compact fluorescent lamp (21) of FIGS. 5 within the downlight reflector (35) of FIG. 12 and FIG. 13, with reflective surfaces (36) directing visible lamp light downwards into a room

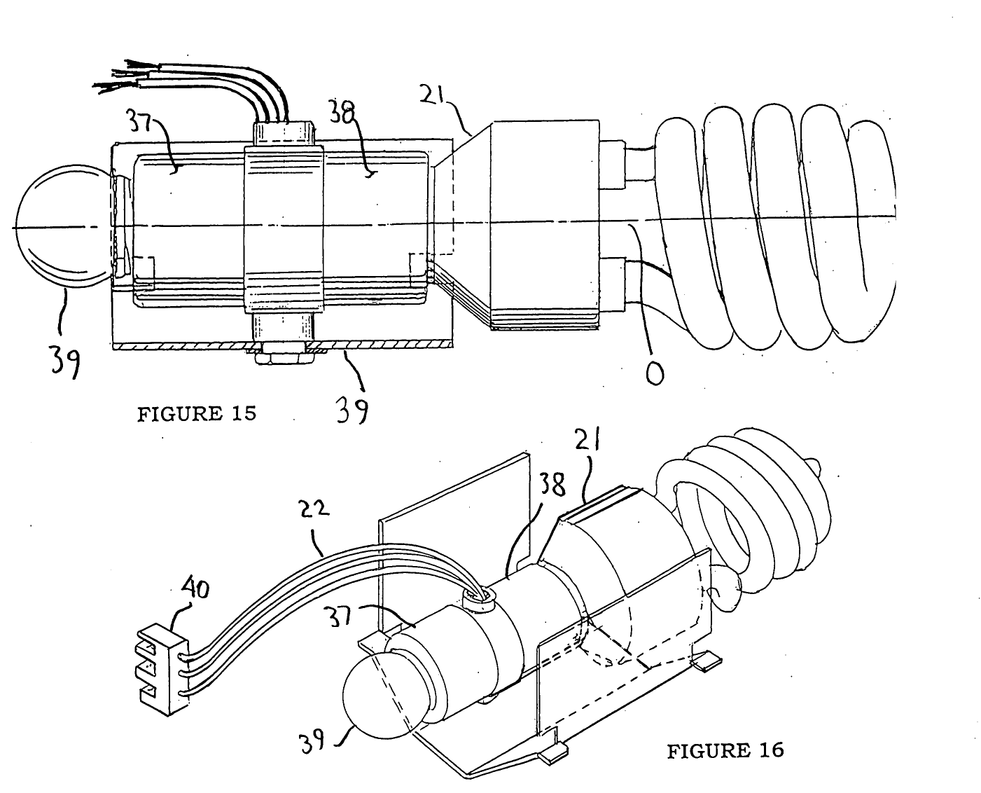

FIG. 15 is a longitudinal cross-sectional view of an alternate embodiment of the present invention having a back-to-back single-circuit lampholders (37, 38) on optical axis (O), and including two incandescent (39) or compact fluorescent lamps (21) operable in a 3-way mode from 3-wire power (22) from a 3-way polarized plug (not shown).

FIG. 16 is a perspective view of selected incandescent (39) and compact fluorescent lamps (21) in the lampholder assembly (9) of FIG. 15, and having 3-wire power (22) from a 3-way polarized plug (40). Since lampholders (37,38) share a neutral electrical connection, either lamp may be energized by energizing the repective power lead, separately or together. Thus lamp (39) could be a 5-watt, 9-watt, 14-watt or 40-watt compact fluorescent lamp, or even a colored incandescent lamp. Power plug (40) also can be energized from either of the two power conductors (8) in either of the two elongated power receptacles (5), making it possible to remotely switch a low-level lamp (39) for night lights or safety lighting, and then turn on higher power lamp (21) when needed for changes in activities or occupancy sensors. Also, selected lampholder assemblies can be energized from the opposite elongated power receptacle (5), to establish light intensity patterns with minimum power use.

REFERENCE NUMERALS IN DRAWINGS

| NUMBER | DESCRIPTION |
|---|---|
| O | optical axis |
| 1 | elongated, recessed tracklight system |
| 1a | inverted U-shaped track |
| 2 | horizontal base of the U |
| 3 | depending vertical sides of the U |
| 4 | outstanding ceiling flanges |
| 5 | elongated electrical receptacles |
| 6 | receptacle mounting channels |
| 7 | polarized slots |
| 8 | electrical conductors |
| 9 | lampholder chassis |
| 10 | lampholder |
| 11 | lampholder chassis upstanding sides |
| 12 | visible-light-transmitting thermal barrier |
| 13 | lampholder chassis base |
| 14 | lampholder chassis outstanding flanges |
| 15 | longitudinal component mounting slots |
| 15a | thermal barrier mounting slots |
| 16 | reflective surfaces of lampholder chassis |
| 17 | track suspension wire |
| 18 | suspended ceiling crossbar T |
| 19 | ceiling panel |
| 20 | miniature reflector lamp |
| 21 | compact fluorescent lamp |
| 22 | lampholder connection wires |
| 23 | polarized electrical plug |
| 24 | lamp filament |
| 25 | dichroic lamp reflector |
| 26 | filter/reflector assembly |
| 27 | filter/reflector bracket |
| 28 | IR-reflecting hot mirror |
| 29 | heat-absorbing filter |
| 30 | downlight aiming mirror |
| 31 | aiming mirror mounting slot |
| 32 | heat-absorbing filter mounting slot |
| 33 | filter/reflector convection aperture |
| 34 | IR-reflecting hot mirror mounting slot |
| 35 | downlight reflector |
| 35a | downlight reflective surfaces |
| 36 | track cooling fins |
| 37 | first single-circuit duplex lampholder |
| 38 | second single-circuit duplex lampholder |
| 39 | low-wattage night light lamp |
| 40 | 3-way operation plug for singly-circuit lampholders |

1) An elongated, recessed tracklight system including:
an elongated metallic main-runner track (1) generally in the shape of an inverted U, having a horizontal base portion (2) and first and second depending vertical sides (3) approximately equally spaced from an optical axis (O), said sides having lower ends extending downwards from the base of the U to form outward-extending flanges (4) in a common plane;
at least one elongated electrical receptacle (5) attached in a channel (6) in a depending vertical side (3), said insulator including 2 polarized longitudinal slots (7) including three partially-imbedded electrical conductors (8), connected to remotely-switched power;
at least one lamp assembly (9) including lamp (20,21) having a substantially IR-energy-emitting portion and a substantially visible-light-emitting portion, said lamp being held and connected in a horizontally positioned screw-base lampholder (10) attached to a chassis (9), said chassis having an upstanding, internally-reflective U-shape around the IR-emitting lamp portion;
a filter/reflector (30,35) intercepting the substantially visible portion of the lamp energy and reflecting it downward; and
an elongated, visible-light-transmitting thermal barrier (12) removably engaged into opposing horizontal slots (15a) in depending vertical sides (3), blocking lamp IR radiation from being emitted below the ceiling.

2) An elongated, recessed tracklight system according to claim 1 in which the lamp (20) is an incandescent lamp that has a parabolic dichroic reflector portion laterally emitting IR energy that is substantially reflected upwards by chassis (9), said lamp also longitudinally emitting collimated visible light, that is substantially reflected downwards by an aimable reflector (30).

3) An elongated, recessed tracklight system according to claim 1 in which the lamp (20) is an incandescent lamp that has a parabolic dichroic reflector portion laterally emitting IR energy that is substantially reflected upwards by chassis (9), said lamp also longitudinally emitting collimated visible light passing horizontally through IR-blocking filters and then substantially reflected downwards by an aimable reflector (30).

4) An elongated, recessed tracklight system according to claim 1 in which the lamp (21) is a compact fluorescent lamp that has a ballast and electrode portion laterally emitting IR energy that is substantially reflected upwards by chassis (9), said lamp also emitting visible radial light from a tubular portion, to be substantially reflected downwards by an inverted U-shaped reflector (35, 36).

5) An elongated, recessed tracklight system according to claim 1 in which the track (1) is a black-anodized aluminum extrusion having high internal heat absorption and high external heat convection and radiation from a number of cooling fins (1a).

6) An elongated, recessed tracklight system according to claim 1 in which the lampholder (10) is a duplex, back-to-back screw-base lampholder (37,38) on optical axis (O) capable of energizing selected incandescent (20,39) or compact fluorescent lamps (21) through 3 wires (22) from a polarized plug (40) connected to a remotely-switched elongated electrical receptacle (5).

7) An elongated, recessed tracklight system according to claim 1 in which the thermal barrier (12) is a single or dual thickness heat and UV absorbing lens selected from transparent materials including polycarbonate, polymethyl methacrylate or polyvinyl chloride.

8) An elongated, recessed tracklight system according to claim 1 in which the track (1) has an upper central suspension point (17) and a pair of outward-extending flanges (4) in a common plane adapted to support either suspended ceiling cross-T members (18) or ceiling panels (19).

9) An elongated, recessed main-runner tracklight system (1) with generally inverted U shaped track having blackbody absorption and emission thermal properties, extending downwards from a suspension point at the base of the U connected to depending vertical sides (3) to outward-extending flanges (4) in a ceiling plane;
at least one lamp (20,21) operated from a remote source of power and having a substantially IR-energy-emitting portion reflected upwards and a substantially visible-light-emitting portion reflected downwards; and
an elongated, visible-light-transmitting thermal barrier (12) removably engaged into opposing horizontal slots (15) in depending vertical sides (3), said thermal barrier blocking lamp IR radiation from being emitted below the ceiling, whereby heat generated by the lamp is reflected, conducted and radiated through the inverted U (9) above the ceiling plane.

10) An elongated, recessed tracklight system according to claim 9 in which lamp (20,21) is operable in a 3-way mode.

11) An elongated, recessed main-runner tracklight system (1) with generally inverted U shaped track having blackbody absorption and emission thermal properties, extending downwards from a suspension point at the base of the U connected to depending vertical sides (3) to outward-extending flanges (4) in a ceiling plane;
at least one lamp (20,21) operated from a remote source of power and having a substantially IR-energy-emitting portion reflected upwards and a substantially visible-light-emitting portion reflected downwards.
